(19) United States
(12) Patent Application Publication
(10) Pub. No.: US 2005/0054680 A1
(43) Pub. Date: Mar. 10, 2005

(54) Agonists and antagonists of 5h3-like receptors of invertebrates as pesticides

(76) Inventors: Stephen Charles Trowell, Oxley (AU); Simon Saubern, St. Kilda East (AU); Chunyan Liao, Red Hill (AU)

Correspondence Address: McDermott Will & Emery, 600 13th Street NW, Washington, DC, 20005-3096, US

(21) Appl. No.: 10/486,702

(22) PCT Filed: Aug. 14, 2002
(86) PCT No.: PCT/AU02/01096

(30) Foreign Application Priority Data
Aug. 14, 2001 (AU) PR 7011

(51) Int. Cl. A01N 43/40; A01N 43/76; A01N 43/26

(52) U.S. Cl. 514/333; 514/374; 514/463

(57) ABSTRACT

The present invention provides compositions and methods for controlling an helminth or arthropod pest. In a preferred embodiment of the invention provided herein, the compositions comprise compounds which alter the 5-HT₃ receptor of the pest. Also claimed are various esters of N-methyl 8-azabicyclo[3.2.1]octan-3-ol (tropan-3-yl esters) and an assay for identifying and/or assessing a helminth and/or arthropod control compound by determining the ability of a candidate compound to modulate the activity of a helminth or arthropod 5-HT₃ receptor.

### FIELD OF THE INVENTION

The present invention relates to methods and compositions for controlling a pest selected from helminths and arthropods.

### BACKGROUND TO THE INVENTION

Many species of nematodes are parasites of considerable medical, veterinary and agricultural significance. For example, nematodes of the Orders Strongylida, Strongyloides, Ascaradida, Oxyurida and Trichocephalida include many species that cause disease in humans, sheep, cattle, pigs and other species. Further, nematodes of the Orders Tylenchida and Aphelenchida, and others, include species which are parasitic of important crop plants and fungi.

It has been conservatively estimated that plant parasitic nematodes cause US $77 billion worth of damage to major food crops annually (Evans and Haydock, 1999). There are, unfortunately, very few control options for plant parasitic nematodes. Fumigants such as methyl bromide are generally being withdrawn from sale and use, because of their detrimental effects on the ozone layer, whilst the remaining available agents are among the most toxic and undesirable pesticides in current use.

Animal parasitic nematodes infect humans, companion animals and livestock and cause serious morbidity and economic loss worldwide. This group of parasites includes hookworms and roundworms. They can cause anaemia, loss of weight, hyperimmune reactions and other complications, including death of livestock. There are currently a small number of human and veterinary drugs available for their treatment but, particularly in the veterinary field, the efficacy of a number of existing drugs is reducing because of resistance development.

For the reasons described, there is an ongoing need for the identification of new nematicidal compounds.

Pharyngeal pumping is the basis of nematode feeding and the ability of nematodes to maintain their “hydrostatic skeleton” (Brownlee et al., 1997). The pharyngeal pump of nematodes is already a well-established target organ for anthelmintics and nematicidal agents. In particular, inhibition of pharyngeal pumping is a major mode of action of ivermectin, an extremely successful modern nematicide and insecticide. Ivermectin acts on inhibitory glutamate receptors present in the pharynx and other tissues of nematodes and insect (Brownlee et al. 1997). Novel compounds that inhibit pumping of the nematode pharynx would have significant potential benefit for the control of plant and animal parasitic nematodes, and other helminth, arthropod and other invertebrate pests. They would also serve as lead molecules to facilitate the discovery process for other nematicidal compounds and insecticidal compounds.

The macrocyclic lactone nematicides (avermectins) exemplify the potential utility of nematicides in controlling other invertebrate pests and parasites. Avermectins were originally registered as anthelminthics but these and related compounds are now being used increasingly as insecticides.

The damage caused by arthropod pests is better known and characterised than that caused by nematodes. For example, the worldwide market for chemical insecticides is about US $12 billion, mostly in crop protection, but also in animal and public health. The market is growing at about 5% p.a. These costs of control are only a fraction of the economic costs of losses to crops and livestock worldwide. In particular, sucking plant pests such as aphids and plant-hoppers are second only to caterpillars in their economic importance and their value as a market for insecticides. They are particularly important in Europe and Asia. Whilst there are some existing insecticides active against these pests, a number of them are highly toxic and development of resistance is also causing problems. Thus, there is a great need for new classes of insecticides active on these pests.

Also, insects with piercing and sucking mouthparts are the main vectors of diseases to humans and livestock. These vectors include mosquitoes (e.g. malaria, Japanese encephalitis, dengue fever etc.), higher flies (e.g. onchocerciasis) and true bugs (e.g. trypanosomiosis). Existing control measures are increasingly reliant on pesticides (e.g. permethrin-treated mosquito nets), because of the absence or failure of drug treatments. Therefore, there is also a need for new classes of insecticides active against these pests.

Serotonin (5-Hydroxytryptamine, 5-HT) has a number of profound effects on the behaviour of Caenorhabditis elegans and other nematodes. In C. elegans, exogenously applied 5-HT results in reduced locomotion, increased pharyngeal pumping, increased egg-laying and decreased defaecation. It is also involved in male mating behaviour. These effects of exogenous 5-HT are believed to occur because 5-HT is a natural nematode neurotransmitter that serves these behaviours. For example, two serotonergic neurones (NSM) are located over the pharynx whilst the HSNL and HSNR serotonergic neurones connect with the vulva. It is quite likely, based on the known biology of 5-HT in vertebrates, that each of these behaviours is controlled by serotonin action on different receptors present in different cells.

Vertebrate serotonin receptors are known to fall into two distinct multigene superfamilies. One of these, the rhodopsin/β-adrenergic receptor superfamily, includes 7-transmembrane G-protein-linked receptors of the 5-HT₁, 5-HT₂, 5-HT₄, 5-HT₅, 5-HT₆, and 5-HT₇ classes. Receptors of the other, 5-HT₃, class belong to the nicotinic-acetylcholine receptor (nAChR), GABA-, glycine- and glutamate-gated ion channel superfamily and are pentameric, 4-membrane-spanning ligand-gated ion channels. It is generally observed that physiologically expressed pentameric receptors of this family comprise two or more types of subunits, with each type being the product of a distinct gene. While functioning ion channels may be obtained experimentally with a pentamer composed of identical subunits, these do not behave identically with respect to their channel conductance properties, to the heteropentameric ion channel that is present in vivo. In the case of the mammalian 5-HT₃ gated ion-channel, faithful electrophysiology has only been obtained with a heteromeric ion channel containing both 5-HT_{3A} and 5-HT_{3B} subunits (Davies et al., 1999). The mammalian 5-HT₃ receptors are known to form channels that gate the passage of cations across the cell membrane and when activated they tend to excite the cell. In this respect, as in many others, their closest relatives are the nicotinic acetylcholine receptors. GABA_{A}-gated, glycine-gated, and the invertebrate-specific glutamate-gated ion channels all gate the passage of anions and their activation generally hyperpolarises the cell membrane.

WO 01/6100 (the entire disclosure of which is to be regarded as incorporated herein by reference) is the first disclosure of the cloning of a cationic 5-HT₃ receptor subunit from an invertebrate species. In addition, WO 01/6100 shows that two 5-HT₃ antagonists (tropanyl dichlorobenzoate and ondansetron) profoundly inhibited pharyngeal pumping while the 5-HT₃ specific agonist 2-methyl-5-hydroxytryptamine hydrochloride strongly and specifically stimulated pharyngeal pumping. Moreover, tropanyl dichlorobenzoate caused dose-dependent mortality and other detrimental effects in C. elegans, and tropanyl dichlorobenzoate and ondansetron caused significant detrimental effects, including some mortality, in insects.

There is a need for further compounds, compositions and methods for controlling helminth and arthropod populations.

### DISCLOSURE OF THE INVENTION

The present inventors have identified compounds which can be used in methods for controlling helminth and/or arthropod populations. Thus, in a first aspect, the present invention provides a method for controlling a pest selected from helminths and arthropods, said method comprising exposing said pest to an effective amount of a compound comprising one of the following formulae: 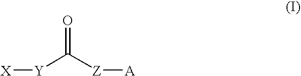
in which,
X is selected from substituted and unsubstituted cyclic rings,
Y is absent or otherwise selected from substituted of unsubstituted alkyl, substituted or unsubstituted alkyloxy, optionally interrupted by one or more heteroatoms,
Z is selected from substituted or unsubstituted alkyl, O, N, NH, S and SH, and
   A is selected from nitrogen-containing substituents; 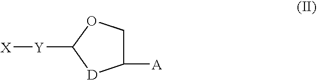
   in which,
X, Y and A are as defined above, and
D is selected from C, CH, CH₂, O and N; and 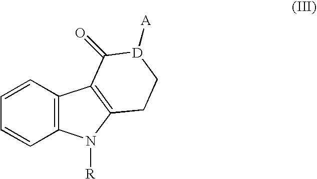
   in which,
A and D are as defined above,
R is H or alkyl;
with the proviso that said compound is not ondansetron or tropanyl dichlorobenzoate.

As used herein, the term “controlling a pest selected from helminths and arthropods” refers to the ability of the compound to have a detrimental effect on the pest. Preferably, the compound has a detrimental effect on pest development, feeding, neural function, reproduction or digestion. More preferably, the compound kills the pest.

In one embodiment, the compound inhibits the activity of a 5-HT₃ receptor of said pest. In another embodiment, the compound stimulates the activity of a 5-HT₃ receptor of said pest.

In one embodiment, X of formula (I) or (II) is a mono- or bicyclic ring. Preferably, X comprises at least one heteroatom.

In another embodiment, X of formula (I) or (II) comprises at least one substituted or unsubstituted aromatic and/or heterocyclic rings which may be fused or non-fused. Preferably X is selected from mono-, di- and tri-substituted phenyl. Preferably, the substituents of such phenyls are selected, independently, from halogens (especially Cl and F), NH₂, N₂O, N(CH₃)₂, lower alkyl (especially methyl and ethyl), lower haloalkyl (especially —CH₂C₁ and CH₂F), lower alkylamino (especially methylamino and ethylamino), lower alkylester (especially methanoate and ethanoate), lower alkyloxy (especially —OCH₃ and —OCH₂CH₃).

In a further embodiment, Y is absent and X is bonded directly to the carbon of the C═O group.

In another embodiment, Y is a substituted or unsubstituted lower alkyl.

In another embodiment, Y is a substituted or unsubstituted lower alkyloxy. More preferably, the lower alkyloxy is selected from —O—CH₂— or —O—CH(CH₃)—.

In a further embodiment, Y is a heteroatom selected from the group consisting of: O, N, NH, S and SH.

Preferably, Z of formula (I) is O or NH.

In a further embodiment, Z of formula (I) is a substituted or unsubstituted lower alkyl.

Preferably, A comprises nitrogen-containing substituents with a basic characteristic. More preferably, A comprises a substituted or unsubstituted 6-8 membered ring. Even more preferably, A is selected from a bridged ring or bicyclic ring, for example an imino bridged ring. More preferably, the imino bridge is —N(CH₃)—.

Alternatively, A may be an alkylamine, for example, —CH₂CH₂N(CH₃)₂, —CH₂CH₂N(Et)₂ etc.

Preferably, A in the compound of formula (III) is a heterocyclic or heterocyclicalkyl. The hetercyclic ring may be a fused or joined directly or indirectly to another heterocyclic or saturated or unsaturated carbocyclic ring. Preferably the heterocylic ring comprises at least one nitrogen atom.

Preferably, D of formula (II) is CH or N.

Preferably, R is lower alkyl.

Particularly preferred compounds are those according to the formula below: 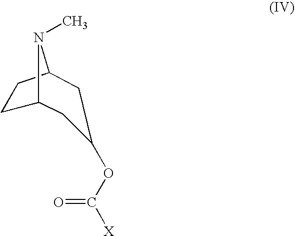
where X is as defined above.

Preferably, X of formula (IV) is selected from substituted and unsubstituted phenyl, phenoxyalkyl (eg phenoxypropyl), phenyl alkyl (eg phenylmethyl), cubanyl carboxylate, cycloalkyl (eg cyclopropane), cycloalkyl carboxylate (eg cydohexane carboxylate), benzylcarboxylate (eg 2-benzyl carboxylate, 3-benzyl carboxylate, 4 benzyl carboxylate), pyridine carboxylate, indolyl (eg 1H-indol-3-yl). The substituents may be any suitable substituent, such as those described above. The substituent(s) may be one or more of a halogen, for example, F and/or Cl.

Particularly preferred is when X of formula (IV) is selected from substituted and unsubstituted phenyl, benzylcarboxylate (eg 2-benzyl carboxylate, 3-benzyl carboxylate, 4 benzyl carboxylate), and indolyl (eg 1H-indol-3-yl). The substituents may be any suitable substituent, such as those described above. The substituent(s) may be one or more of a halogen, for example, F and/or Cl.

More preferably, the compound is selected from the group consisting of 3-chloro-benzoic acid tropan-3-yl ester, 3,4-dichloro-benzoic acid tropan-3-yl, 2-fluoro-benzoic acid tropan-3-yl ester, phthalic acid methyl ester tropan-3-yl ester, and 1H-indole-3-carboxylic acid tropan-3-yl.

Suitable “lower alkyl” and lower alkyl moieties in the terms “lower haloalkyl”, “lower alkylamino”, “lower alkylester”, and “lower alkyloxy may be straight or branched such as methyl, ethyl, propyl, isopropyl, butyl, isobutyl, tert-butyl, pentyl, hexyl or the like.

The formulae given herein are intended to extend to all possible geometrical and optical isomers as well as racemic mixtures thereof.

Preferably the helminth is selected from the group consisting of: nematodes, cestodes and flatworms. More preferably, the nematode is an animal parasitic nematode or a plant parasitic nematode. Preferably, the arthropod is an insect. More preferably, the pest has a feeding mechanism involving sucking plant or animal fluids by means of a muscular pump, such as those generally referred to as sucking insects. Examples of sucking insects which can be controlled by the methods of the present invention include, but are not limited to, Thrips (Thysanoptera) such as Frankliniella occidentalis, Thrips palmi; Plant/Leaf bugs, Lace Bugs, Kissing bugs (Hemiptera:Reduviidae) such as Rhodnius prolixus, Triatoma spp; Leaf/Plant/Tree hoppers (Hemiptera) such as Nilaparvata lugens (rice planthopper), Empoasca fabae; Psyllids (Hemiptera) such as Diaphorina citri; Aphids (Hemiptera) such as Myzus persicae, Aphis gossypii, Aphis craccivora, Acyrthosiphon pisum, Acyrthosiphon kondoi, Diuraphis noxia, Schizaphis graminum, Sitobion avenae, Rhopalosiphum padi, Rhopalosiphum maidis, Diuraphis noxia, Schizaphis graminum, Sitobion avenae, Macrosiphum euphorbiae, Brevicoryne brassicae, Lipaphis erysimi, Theriaphis trifolii; Whiteflies (Hemiptera) such as Bemisia tabaci, Bemisia argentifolii, Trialeurodes vaporariorum; Mealybugs; Scales; Mosquitoes (Diptera) such as Anopheles gambiae, Anopheles stephensi, A. maculipennis and other Anopheles spp. Culex pipiens and other Culex spp. Aedes aegyptae, Aedes albopictus and other Aedes spp, Haemagogus equinus; Blackflies (Diptera) such as Simulium damnosum. Examples of non-insect arthropods which can be controlled by the methods of the present invention include, but are not limited to, Mites (Acarina) such as Spider mites (eg Tetranychus urticae) and Eriophyid mites; and Ticks such as Boophilus spp. Examples of nematodes (Nematoda) which can be controlled by the methods of the present invention include, but are not limited to, Onchocerca volvulus, Dracunculus spp, Trichuris spp., Wuchereria bancrofti, Strongyloides stercoralis, other Strongyloides spp, Brugia malayi, Angiostrongylus vasorum, Toxocara canis, T. cati, Baylisascaris procyoni, Ancylostoma duodenal and other Ancylostoma spp., Necator americanus and other Necator spp, Haemonchus contortus and other Haemonchus spp, Ostertagia spp, Trichostrongylus colubriformis, Ascaris suum, A. caninum, A. braziliense, and A. tubaeforme and other Ascaris sp. Trichinella spp., Meloidogyne incognita and other Meloidogyne species, Globodera pallida and other Globodera spp, Pratylenchus thomei, P. neglectus and other Pratylenchus sp., Ditelenchus sp.

An effective amount of said compound may be in the range of 100 μM or less, preferably 10 μM or less, more preferably 1 μM or less at the whole organism level.

In a second aspect, the present invention provides a composition for controlling a pest selected from helminths and arthropods, said composition comprising a compound as defined in the first aspect in combination with a pharmaceutically/veterinary/agriculturally-acceptable carrier and/or excipient.

The present inventors have also synthesised numerous new compounds. Thus, in a third aspect the present invention provides a compound of the formulae: 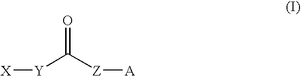
in which,
X is selected from substituted and unsubstituted cyclic rings,
Y is absent or selected from lower alkyl, lower alkyloxy, O, N, NH, S and SH,
Z is O and
A is tropanyl,
   with the proviso that compound is not tropanyl dichlorobenzoate.

Preferably, Y is absent.

Preferably the compound is of formula: 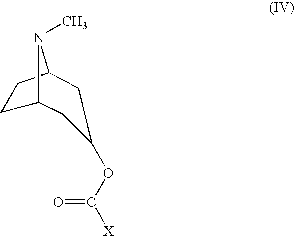
where X is as defined above.

Preferably, X of formula (IV) is selected from substituted and unsubstituted phenyl, phenoxyalkyl (eg phenoxypropyl), phenyl alkyl (eg phenylmethyl), cubanyl carboxylate, cycloalkyl (eg cyclopropane), cycloalkyl carboxylate (eg cyclohexane carboxylate), benzylcarboxylate (eg 2-benzyl carboxylate, 3-benzyl carboxylate, 4 benzyl carboxylate), pyridine carboxylate, indolyl (eg 1H-indol-3-yl). The substituents may be any suitable substituent, such as those described above. The substituent(s) may be one or more of a halogen, for example, F and/or Cl.

Particularly preferred is when X of formula (IV) is selected from substituted and unsubstituted phenyl, benzylcarboxylate (eg 2-benzyl carboxylate, 3-benzyl carboxylate, 4 benzyl carboxylate), and indolyl (eg 1H-indol-3-yl). The substituents may be any suitable substituent, such as those described above. The substituent(s) may be one or more of a halogen, for example, F and/or Cl.

Preferably, the compound is selected from the group consisting of 3-chloro-benzoic acid tropan-3-yl ester, 3,4-dichloro-benzoic acid tropan-3-yl ester, 2-fluoro-benzoic acid tropan-3-yl ester, phthalic acid methyl ester tropan-3-yl ester, and 1H-indole-3-carboxylic acid tropan-3-yl.

The present invention also allows for the compounds defined herein to be screened for their ability to be used as a helminth and/or arthropod control compound. Thus, in a fourth aspect, the present invention provides an assay for identifying and/or assessing an helminth and/or arthropod control compound, the method comprising determining the ability of a compound defined herein to modulate the activity of a 5-HT₃ receptor of the helminth or arthropod.

The assay can be performed in an in vitro or in vivo system. In an example of an in vitro system, the 5-HT₃ receptor, or functionally equivalent fragment thereof, is expressed in a recombinant host cell and the ability of the candidate modulate compound is measured on the host cell. An example of an in vivo avenue of performing the assay is the “automated feeding assay” described herein.

Preferably, the modulation of 5-HT₃ activity is determined by measuring changes in cell membrane potential or Ca²⁺ levels.

Preferably, the 5-HT₃ receptor(s) is contacted simultaneously with a serotonergic ligand and the candidate compound, and the modulation of 5-HT₃ activity is determined by measuring the amount of bound and/or unbound labelled serotonergic ligand. More preferably, said serotonergic ligand is 5-hydroxytryptamine.

In one embodiment, the compound inhibits the activity of a 5-HT₃ receptor of said helminth and/or arthropod. In another embodiment, the compound stimulates the activity of a 5-HT₃ receptor of said helminth and/or arthropod.

In a fifth aspect, the present invention provides an helminth or arthropod control compound identified according to the fourth aspect.

A lead compound is an helminth or arthropod control compound which is subject to trials with the goal of ultimately being formulated in, for example, a composition and sold as an agent for controlling helminth or arthropod pest populations. The lead compound, when exposed to a helminth or arthropod, more preferably an insect, disrupts 5-HT₃ receptor activity leading to a reduction in reproduction rates, a reduction in feeding rates or death etc.

As will be apparent, preferred features and characteristics of one aspect of the invention are applicable to many other aspects of the invention.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

The invention will hereinafter be described with reference to the following non-limiting examples and accompanying figures.

### BRIEF DESCRIPTION OF THE ACCOMPANYING FIGURES

FIG. 1: Structural formulae of compounds used or mentioned in Example 1.

FIG. 2: Log dose responses for bead ingestion by nematodes. Compounds identified as strongly reversing the stimulatory effects of 0.325 mM serotonin on bead ingestion (see Table 3) were tested over a range of doses. The results were plotted as percentage of the fluorescence due to bead ingestion in the presence of 1 mM serotonin alone. Data were fitted to the equation y=a/(1+Exp(b−c*x)) by iterative least squares regresssion in DeltaGraph version 4.05 and 4.5 for the Macintosh (SPSS Australasia Pty Ltd).

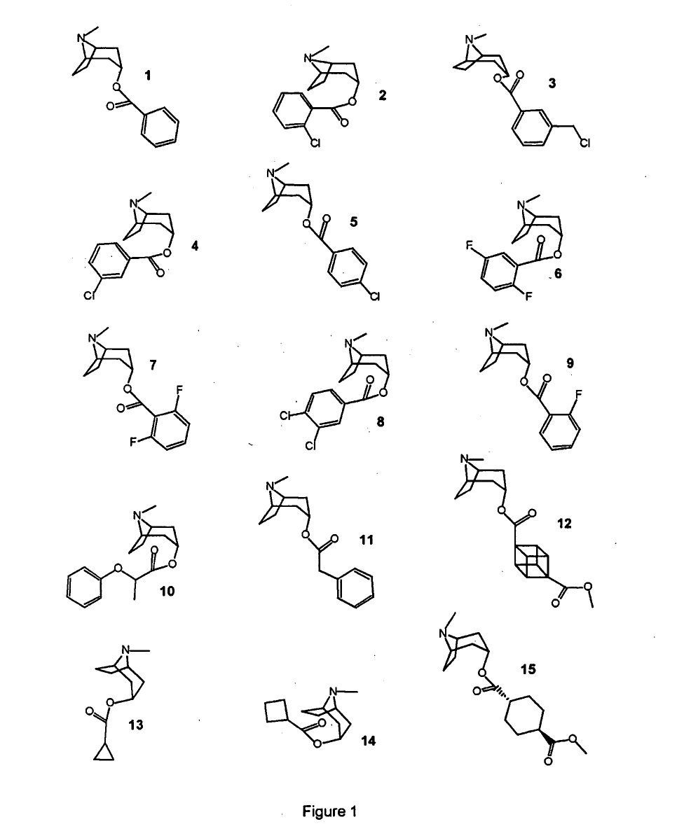

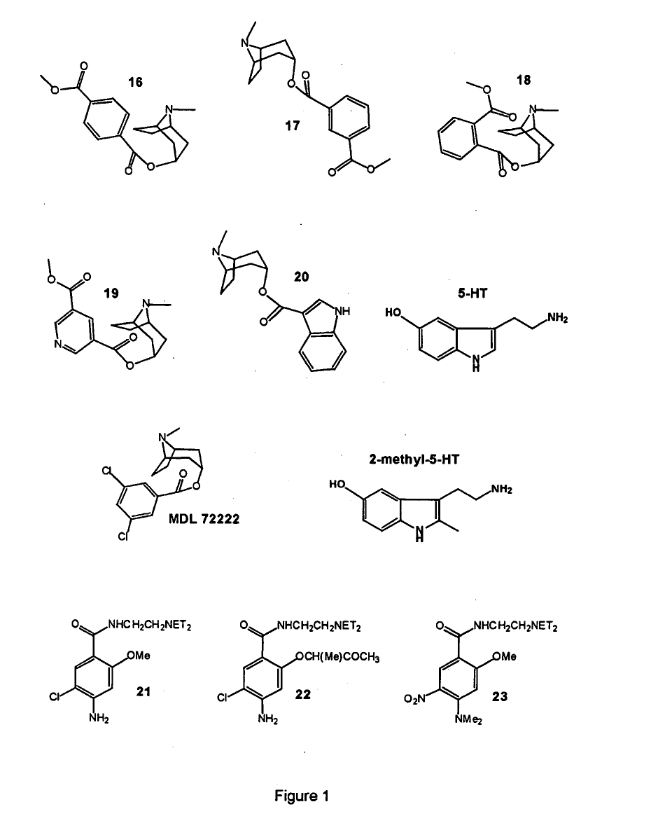

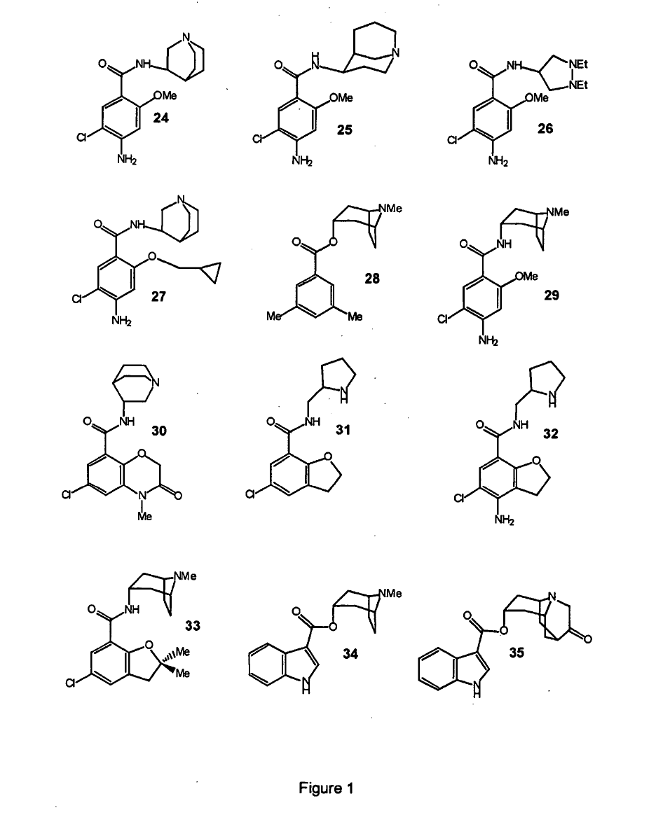

### DETAILED DESCRIPTION OF THE INVENTION

5-HT₃ Receptor

The term “5-HT₃ receptor” as used herein refers to a receptor having one or more of the following features (1)-(3):
(1) Is a serotonin-gated molecular ion-channel which gates the conductance of cations and is composed of five receptor subunits each of which has a nicotinicoid transmembrane topology (N-terminus, large extracellular domain, 3 transmembrane helices, large intracellular domain, 1 transmembrane helix, C-terminus).
(2) Is a helminth or arthropod receptor composed of subunits with a higher level of amino acid homology to mammalian 5-HT₃ receptor subunits (such as those described by Maricq et al. (1991); Miyake et al. (1995) and U.S. Pat. No. 6,365,370) than to known mammalian nicotinic acetylcholine receptor subunits.
(3) Has a characteristic pharmacological profile in that it binds to a subset of known 5-HT₃-specific agonists and antagonists with greater selectivity than it binds to agonists and antagonists of other 5-HT receptor classes.

Examples of 5-HT₃ receptors, the activity of which is altered by the compounds described herein, are provided in co-pending application WO 01/61000. These receptors include those naturally occurring in pest species which posses a sequence which is at least 50% identical, more preferably at least 60% identical, more preferably at least 70% identical, more preferably at least 80% identical, more preferably at least 90% identical, more preferably at least 95% identical, more preferably at least 97% identical, and even more preferably at least 99% identical to the those 5-HT₃ receptors disclosed in WO 01/61000 and provided herein as SEQ ID NO's 1 to 3.

As used herein a “functionally equivalent fragment” of a 5-HT₃ receptor is a portion of the receptor which has at least one of features (1) to (3) as outlined above.

5-HT₃ receptors useful for assays of the present invention can either be naturally occurring or mutants and/or fragments (especially functionally equivalent fragments) thereof.

The % identity of a polypeptide is determined by GAP (Needleman and Wunsch, 1970) analysis (GCG program) with a gap creation penalty=5, and a gap extension penalty=0.3. The query sequence is at least 15 amino acids in length, and the GAP analysis aligns the two sequences over a region of at least 15 amino acids. More preferably, the query sequence is at least 50 amino acids in length, and the GAP analysis aligns the two sequences over a region of at least 50 amino acids. Even more preferably, the query sequence is at least 100 amino acids in length and the GAP analysis aligns the two sequences over a region of at least 100 amino acids. More preferably, the query sequence is at least 250 amino acids in length and the GAP analysis aligns the two sequences over a region of at least 250 amino acids. Even more preferably, the query sequence is at least 500 amino acids in length and the GAP analysis aligns the two sequences over a region of at least 500 amino acids.

Compositions

The composition may be in any form known in the art including, but not limited to, a solid form (e.g. oral dosage forms for pharmaceutical or veterinary use, or pellets for agricultural or horticultural use which may be cast or spread onto an area or surface affected by the target pest), in liquid forms for application by, for example, spraying techniques, or as suspensions or syrups.

Typical pharmaceutically/veterinary/agriculturally-acceptable carriers and/or excipients which may be employed in the compositions according to the invention include, but are not limited to, preservatives, buffering systems, viscosity enhancing agents, flavouring aids, colouring aids, sweeteners, and mixtures thereof.

Suitable carriers for the compounds provided as formulae (I) and (IV) include dimethyl sulfoxide (DMSO).

Suitable preservatives include one or more alkyl hydroxybenzoates such as methyl, ethyl, propyl and/or butyl hydroxybenzoates; sorbic acid or a salt thereof; benzoic acid or a salt thereof; and mixtures thereof.

Suitable buffering systems include combinations of citric acid and salts and solvates thereof, for example citric acid (anhydrous or monohydrate) combined with sodium citrate dihydrate.

Suitable viscosity enhancing agents include gums (e.g. Xanthan gum); glycerol; polyvinyl alcohol; polyvinylpyrrolidine; cellulose derivatives, such as carboxymethylcellulose or a salt thereof, C₁₋₄ alkyl and/or hydroxy C₂₋₄ alkyl ether of cellulose, such as methylcellulose, ethylcellulose, hydroxyethylcellulose, hydroxypropylcellulose, hydroxyethylmethylcellulose and hydroxypropyl-methylcellulose; and mixtures thereof.

Liquid compositions according to the invention conveniently have a viscosity which lies in the range 1 to 100 cps, such as 10 to 75 cps, for example about 15 to 50 cps.

Suitable additional sweeteners include, for example, sugars such as glucose; and cyclamate and salts thereof.

Preferably, the compositions contain compounds which attract target pests, and/or repel non-target organisms (such as beneficial insects, mammals etc).

### EXAMPLE

It had been previously observed that mammalian 5-HT₃ specific drugs affect the rate of pharyngeal pumping in the nematode C. elegans indicating the presence of an excitatory serotonin-gated ion channel in nematodes which controls the rate and strength of pharyngeal pumping (WO 01/61000). Specifically, it was observed that the drugs 3,5-dichlorobenzoic acid tropan-3-yl ester (tropanyl dichlorobenzoate, MDL 72222) and ondansetron (also known as zofran), both at concentrations of 0.325 mM, antagonised the stimulatory effect of 0.325 mM serotonin on the rate of pharyngeal pumping. The drug 2-methyl-5-hydroxytryptamine at 3 mM strongly stimulated pharyngeal pumping but, unlike a similar dose of serotonin, did not inhibit locomotion. It had also been observed that tropanyl dichlorobenzoate had a range of dose-dependent detrimental effects, including lethality, on C. elegans and the aphid Myzus persicae and also caused reduced growth rates in the larvae of the lepidopteran Helicoverpa armigera.

Pharyngeal pumping is a vital function for nematodes since it is necessary for feeding and maintenance of the hydrostatic skeleton. Furthermore, the pharynx, or a functionally equivalent pump at the anterior end of the gut, is vital for many other invertebrates since the pump is required for ingestion of food (e.g. aphids) attachment to the host (e.g. trematodes).

An automated screening assay has been developed and described in the present Applicants' co-pending International patent application No. PCT/AU00/01476 (WO 01/40500). Using the screening assay, twenty novel tropanyl ester compounds as well as tropanyl dichlorobenzoate were screened for nematicidal activity.

Materials and Methods

Drugs

Serotonin. (5-Hydroxytryptamine creatinine sulphate, C₁₄H₁₉N₅O₂.H₂SO₄1H₂O) was obtained from Sigma-Aldrich Corporation, Castle Hill, NSW.

Tropanyl dichlorobenzoate. (3-Tropanyl-3,5-dichlorobenzoate, C₁₅H₁₇Cl₂NO₂) was obtained from RBI Research Biochemicals International, Natick, Mass., USA.

Ondansetron HCl (C₁₈H₁₉N₃O.HCl 2H₂O) was donated by Dr. Paul Cooper of the Division of Botany and Zoology, Australian National University.

2-methyl-5-hydroxytryptamine hydrochloride (C₁₁H₁₄N₂O.HCl H₂O) was obtained from Tocris Cookson Ltd., Avonmouth, UK.

Synthetic Tropanyl Ester Compounds

The tropanyl esters shown in Table 1 were synthesised as described below.

TABLE 1
Tropanyl esters.

| | |
|---|---|
| DCP-45221 (1) | benzoic acid tropan-3-yl ester |
| DCP-45222 (2) | 2-chloro-benzoic acid tropan-3-yl ester |
| DCP-45223 (3) | 3-chloromethyl-benzoic acid tropan-3-yl ester |
| DCP-45224 (4) | 3-chloro-benzoic acid tropan-3-yl ester |
| DCP-45225 (5) | 4-chloro-benzoic acid tropan-3-yl ester |
| DCP-45226 (6) | 2,5-difluoro-benzoic acid tropan-3-yl ester |
| DCP-45227 (7) | 2,6-difluoro-benzoic acid tropan-3-yl ester |
| DCP-45228 (8) | 3,4-dichloro-benzoic acid tropan-3-yl ester |
| DCP-45229 (9) | 2-fluoro-benzoic acid tropan-3-yl ester |
| DCP-45230 (10) | 2-phenoxy-propionic acid tropan-3-yl ester |
| DCP-45231 (11) | phenyl-acetic acid tropan-3-yl ester |
| DCP-45232 (12) | cubane-1,4-dicarboxylic acid methyl ester tropan-3-yl |
| | ester |
| DCP-45233 (13) | cyclopropanecarboxylic acid tropan-3-yl ester |
| DCP-45234 (14) | cyclobutanecarboxylic acid tropan-3-yl ester |
| DCP-45235 (15) | trans-cyclohexane-1,4-dicarboxylic acid methyl ester |
| | tropan-3-yl ester |
| DCP-45236 (16) | terephthalic acid methyl ester tropan-3-yl ester |
| DCP-45237 (17) | isophthalic acid methyl ester tropan-3-yl ester |
| DCP-45238 (18) | phthalic acid methyl ester tropan-3-yl ester |
| DCP-45239 (19) | pyridine-3,5-dicarboxylic acid methyl ester tropan- |
| | 3-yl ester |
| DCP-45240 (20) | 1H-indole-3-carboxylic acid tropan-3-yl ester |

Preparation of Tropanyl Esters

Acid chlorides were used where commercially available (Table 2). Where only a carboxylic acid was commercially available, it was first converted to the acid chloride before use by well known techniques (March, 1985).

The tropanyl esters were prepared using parallel synthesis techniques in 4×6 microtitre plate arrays (Bunnin, 1998). Into each well of the microtitre plate was placed tropan-3-ol (100 mg) followed by dichloromethane (4 ml) then triethylamine (0.5 ml). Each well was treated with a solution or suspension of an acid chloride (1.05 molar equivalents) in dichloromethane (2 ml). The reactions were allowed to react overnight. Water (50 μl) was added into each well, and the reaction plate agitated for 2 h. The reactions were concentrated under a vacuum at 45° C. Each sample was purified by LC/MS (ESI mode) on a Reverse Phase C-18 ODS-AL 20 mm×50 mm column from YMC, then concentrated to afford a solid or oil.

Automated Feeding Assay

The assay used was essentially that described in WO 01/40500 with minor modifications. The protocol was as follows:

(1.) Plate Culture. C. elegans of the Bristol N2 strain (Brenner, 1974) were cultured at room temperature on HMS174 E. coli bacteria (Campbell et al., 1978) spread on a 150 mm diameter petri dish containing enhanced NGM 1.7% (w/v) (Avery and Horvitz, 1990) agar until a good population of adult nematodes was present, but food reserves had not been exhausted.

(2.) The nematodes were collected by washing each plate with 10 mL and then 5 mL of M9 buffer plate and filtering over a 20 μm nylon mesh (Nytal—Catalogue no. BCNY-HDO02-20) to retain adult nematodes. The nematodes from 7-8 of these 150 mm plates were collected together and placed on a 63 μm mesh filter (Nytal—product code PA-25-43) and washed with 200-250 mL of M9 buffer or MilliQ water. This procedure allows the passage of nematodes whilst retaining larger debris. Finally the nematodes were collected over a 20 μm mesh.

(3.) Adult nematodes were collected from the mesh using a pasteur pipette and allowed to settle in an eppendorf tube at 1×g for 10 minutes. This packed volume was used to calculate quantities of nematodes for experiments and assays, although nematodes were resuspended in 2-10 volumes of M9 buffer for transfer. Quantitative transfers of nematodes were performed using a Gilson Pipetman P200 or equivalent and a yellow tip with 5 mm cut off the sharp end.

TABLE 2
Synthesis of the tropan-3-yl esters in this study.

| | | Product Information | | |
|---|---|---|---|---|
| Name of the carboxylic acid | | | mol | |
| parent of the acid chloride reacted | formula | mol weight | weight | tropanyl ester |
| with tropan-3-ol | (calc) | (calc) | (obs)^{a} | designation |
| benzoic acid | C₁₅H₁₉NO₂ | 245.14 | 246.4 | DCP-45221 (1) |
| 2-chloro-benzoic acid | C₁₅H₁₈CINO₂ | 279.10 | 280.0 | DCP-45222 (2) |
| 3-chloromethyl-benzoic acid | C₁₆H₂₀CINO₂ | 293.12 | 294.2 | DCP-45223 (3) |
| 3-chloro-benzoic acid | C₁₅H₁₈CINO₂ | 279.10 | 280.0 | DCP-45224 (4) |
| 4-chloro-benzoic acid | C₁₅H₁₈CINO₂ | 279.10 | 280.0 | DCP-45225 (5) |
| 2,5-difluoro-benzoic acid | C₁₅H₁₇F₂NO₂ | 281.12 | 282.0 | DCP-45226 (6) |
| 2,6-difluoro-benzoic acid | C₁₅H₁₇F₂NO₂ | 281.12 | 282.0 | DCP-45227 (7) |
| 3,4-dichloro-benzoic acid | C₁₅H₁₇Cl₂NO₂ | 313.06 | 314.0 | DCP-45228 (8) |
| 2-fluoro-benzoic acid | C₁₅H₁₈FNO₂ | 263.13 | 264.2 | DCP-45229 (9) |
| 2-phenoxy-propionic acid | C₁₇H₂₃NO₃ | 289.17 | 290.0 | DCP-45230 (10) |
| phenyl-acetic acid | C₁₆H₂₁NO₂ | 259.16 | 260.0 | DCP-45231 (11) |
| cubane-1,4-dicarboxylic acid | C₁₉H₂₃NO₄ | 329.16 | 330.0 | DCP-45232 (12) |
| monomethyl ester | | | | |
| cyclopropanecarboxylic acid | C₁₂H₁₉NO₂ | 209.14 | 210.2 | DCP-45233 (13) |
| cyclobutanecarboxylic acid | C₁₃H₂₁NO₂ | 223.16 | 224.0 | DCP-45234 (14) |
| trans-Cyclohexane-1,4-dicarboxylic | C₁₇H₂₇NO₄ | 309.19 | 310.2 | DCP-45235 (15) |
| acid monomethyl ester | | | | |
| terephthalic acid monomethyl ester | C₁₇H₂₁NO₄ | 303.15 | 304.2 | DCP-45236 (16) |
| isophthalic acid monomethyl ester | C₁₇H₂₁NO₄ | 303.15 | 304.2 | DCP-45237 (17) |
| phthalic acid monomethyl ester | C₁₇H₂₁NO₄ | 303.15 | 304.2 | DCP-45238 (18) |
| pyridine-3,5-dicarboxylic acid | C₁₆H₂₀N₂O₄ | 304.14 | 305.2 | DCP-45239 (19) |
| monomethyl ester | | | | |
| 1H-indole-3-carboxylic acid | C₁₇H₂₀N₂O₂ | 284.15 | 285.0 | DCP-45240 (20) |

^{a}Molecular ions obtained in +ESI mode, giving M + H ions, on a PE-Sciex API-150EX.

(4.) Assays were performed in 24 well tissue-lture clusters (Nunc multidish). The final assay volume was 230 μL comprising the following sequential additions:
(i) M9 buffer—sufficient to bring the final volume to 230 μL
(ii) Serotonin—11.5 μL of a 20 mM stock solution in water
(iii) Any other pharmacological agents—≦1.5 μL of drug in DMSO (or water)
(iv) Nematodes—150 μL of a 10% (v/v) stock in M9
(v) Fluorescent beads—23 μL of a 1% w/v solution in M9.

Where serotonin or other pharmacological agents were omitted, the volume was adjusted with M9 buffer. Control experiments included 1.5 μL of DMSO except in the case of ondansetron, which was added from an aqueous stock.

The fluorescent beads were 1.30 μm uniformly dyed microsphere beads with a hydrophilic surface-coating. The fluorescence excitation maximum was 420 nm and the emission maximum was 485 nm (catalogue code FC04F, carboxylate-modified polystyrene/polyvinyl copolymer, manufactured and supplied by Bangs Laboratories, Inc. 9025 Technology Drive, Fishers, INDIANA 46038-2886, USA).

(5.) The nematodes were incubated for 60 minutes after the addition of the fluorescent beads at room temperature (≈21° C.) without shaking. The assay was terminated by the addition of 20 μL of 100 mM sodium azide.

(6.) Two aliquots of 100 μl each were transferred from each well of the 24 well cluster to a pair of wells in a pre-blocked mesh-bottomed plate (see below for details of the mesh-bottomed plate) and the buffer/bead suspension was immediately aspirated away through the filter mesh using a Millipore Multiscreen vacuum manifold.

(7.) A total of eight washing steps were performed. Each of the first five washes used 200 μL of 1%(w/v) sodium lauryl sulphate (SDS—Sigma) in M9 buffer. The third and fifth washes involved pipetting the solution up and down in the wells of the plate ten times each wash. The SDS washes were followed by three washes with 200 μL of M9 buffer only. At the end of each washing step, solutions were aspirated away through the mesh using a Millipore Multiscreen vacuum manifold.

(8.) 50 μL M9 was added to the wells of the mesh plate and it was placed on a piece of black cardboard before being read in the PolarStar fluorimeter with excitation at 420 nm and emission at 485 nm and with the gain set at 30.

(9.) Preparation of 96-well mesh-bottomed plates. Millipore Multiscreen N20 plates, (custom order no. SE3R090M6) were blocked prior to performing the assay in order to minimise non-specific adherence of fluorescent microsphere beads. To block, 200 μL of a 0.1% (w/v) suspension of dark blue-dyed, non-fluorescent microsphere beads with a mean diameter of 0.95 μm and a hydrophilic surface coating (Catalogue code DC03B, carboxylate-modified polystyrene/polyvinyl copolymer) (manufactured and supplied by Bangs Laboratories, Inc. 9025 Technology Drive, Fishers, INDIANA 46038-2886, USA) were added to the plate and incubated overnight at room temperature with orbital shaking at 70 r.p.m. Prior to addition of the nematode sample, the bead suspension was removed under vacuum using a Millipore Multiscreen manifold. The plate was washed three times by pipetting 200 μL of M9 buffer into each well, allowing the plate to sit for 5 minutes and then sucking off the suspension.

(10.) The fluorescence reading in the presence of 0.325 mM MDL 72222 was defined as background. When measuring the efficacy of antagonists the fluorescence reading in the presence of 1 mM added 5-HT was defined as 100% (note that higher concentrations of serotonin are capable of eliciting higher responses).

Results

The results of screening of twenty novel tropanyl esters and tropanyl dichlorobenzoate for nematicidal activity using the automated screening assay are shown at Table 3. Compounds, each at 0.325 mM, were tested for their effects in isolation and in combination with 0.325 mM serotonin. DCP-45224 (4), DCP-45228 (8), DCP-45229 (9), DCP-45238 (18), and tropanyl dichlorobenzoate strongly reversed the stimulatory effect of 0.325 mM serotonin. Of these DCP-45228 (8) and tropanyl dichlorobenzoate also reduced the unstimulated level of bead ingestions. The compounds that exhibited strong effects at 0.325 mM concentration compounds were investigated further.

The selected compounds were tested over a range of doses for their effects on bead ingestion in the presence of 1 mM serotonin. Tropanyl dichlorobenzoate was also tested in the absence of added serotonin, i.e. for its

TABLE 3
Effects of tropanyl esters on nematode pharyngeal pumping measured by the bead
ingestion assay in the presence and absence of serotonin.

| | | | Effect of 0.325 mM |
|---|---|---|---|
| | | Effect of | compound on serotonin- |
| | | 0.325 mM compound | stimulated (0.325 mM) |
| Compound no. | Compound name | on bead ingestion | bead ingestion |
| MDL 72222 | 3,5-dichlorobenzoic acid tropan-3-yl ester | inhibits | reverses strongly |
| DCP-45221 (1) | benzoic acid tropan-3-yl ester | stimulates marginally | potentiates marginally |
| DCP-45222 (2) | 2-chlorobenzoic acid tropan-3-yl ester | no effect | no effect |
| DCP-45223 (3) | 3-chloromethyl-benzoic acid tropan-3-yl | no effect | no effect |
| | ester | | |
| DCP-45224 (4)* | 3-chloro-benzoic acid tropan-3-yl ester | no effect | reverses strongly |
| DCP-45225 (5) | 4-chloro-benzoic acid tropan-3-yl ester | no effect | no effect |
| DCP-45226 (6) | 2,5-difluoro-benzoic acid tropan-3-yl ester | no effect | reverses marginally |
| DCP-45227 (7) | 2,6-difluoro-benzoic acid tropan-3-yl ester | no effect | reverses marginally |
| DCP-45228 (8)* | 3,4-dichloro-benzoic acid tropan-3-yl ester | inhibits | reverses strongly |
| DCP-45229 (9)* | 2-fluoro-benzoic acid tropan-3-yl ester | no effect | reverses marginally |
| DCP-45230 (10) | 2-phenoxy-propionic acid tropan-3-yl ester | inhibits | reverses marginally |
| DCP-45231 (11) | phenyl-acetic acid tropan-3-yl ester | inhibits | reverses marginally |
| DCP-45232 (12) | cubane-1,4-dicarboxylic acid methyl ester | no effect | reverses marginally¹ |
| | tropan-3-yl ester | | |
| DCP-45233 (13) | cyclopropanecarboxylic acid tropan-3-yl | no effect | potentiates marginally |
| | ester | | |
| DCP-45234 (14) | cyclobutanecarboxylic acid tropan-3-yl ester | no effect | no effect |
| DCP-45235 (15) | trans-cyclohexane-1,4-dicarboxylic acid methyl | no effect | no effect/reverses |
| | ester tropan-3-yl ester | | marginally |
| DCP-45236 (16) | terephthalic acid methyl ester tropan-3-yl | no effect | no effect |
| | ester | | |
| DCP-45237 (17) | isophthalic acid methyl ester tropan-3-yl | no effect | no effect |
| | ester | | |
| DCP-45238 (18)* | phthalic acid methyl ester tropan-3-yl ester | no effect | reverses markedly |
| DCP-45239 (19) | pyridine-3,5-dicarboxylic acid methyl ester | no effect | potentiates marginally |
| | tropan-3-yl ester | | |
| DCP-45240 (20)* | 1H-indole-3-carboxylic acid tropan-3-yl ester | no effect | reverses markedly |

¹Observed with an unpurified mixture
*Samples selected for further study

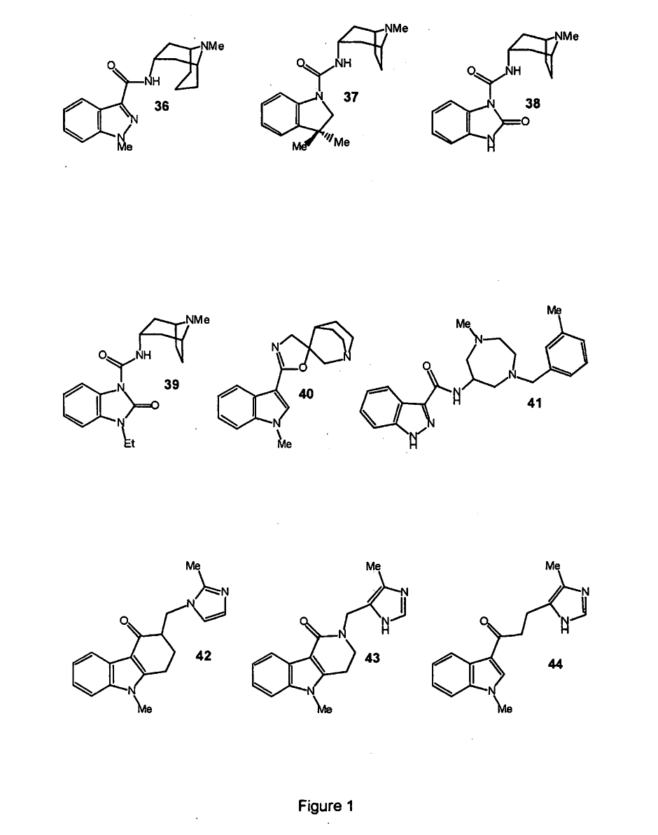

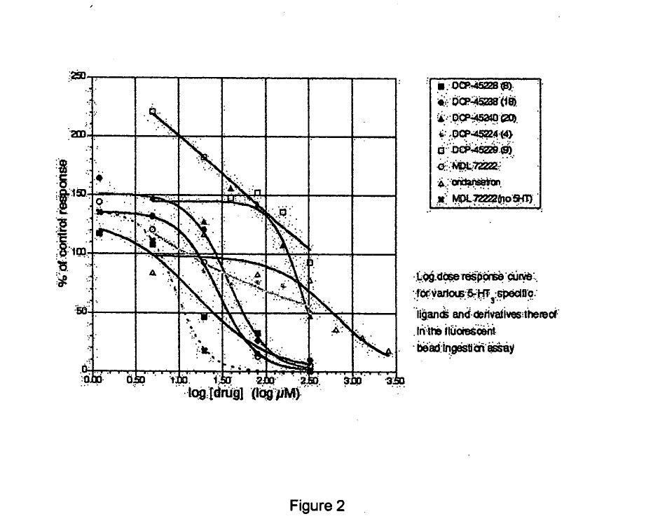

ability to depress the basal level of pumping due to endogenous serotonin release by the serotonergic cells of the nematode. The data were converted into percentages of the response in the presence of 1 mM serotonin and a log dose response curve was plotted (FIG. 2.). Where possible, the data were fitted with a logistic equation.

IC₅₀ (inhibitory concentration—50%) values were estimated from the curves. In the presence of 1 mM serotonin these were:
DCP-45228 (8)=25 μM
MDL 72222=40 μM
DCP-45238 (18)=56 μM
DCP-45240 (20)=316 μM
ondansetron=562 μM

It was impossible to estimate the IC₅₀ values for DCP-45224 (4) and DCP-45229 (9) under these conditions because of the lower potency of these compounds. In addition DCP-45229 (9) exhibited anomalous activity with very strong stimulatory effects at lower doses.

In the absence of added serotonin, the IC₅₀ value for tropanyl dichlorobenzoate (i.e. the dose that depressed the basal bead ingestion rate by 50%) was estimated at 11 μM (FIG. 2—dotted black line). This indicates an effective endogenous level of serotonin equivalent to approximately 0.5 mM exogenous serotonin. Interestingly, 11 μM is very close to the lowest effective concentration in the chronic toxicity assay reported previously (see WO 01/61000). The correspondence of the effective doses in the bead ingestion and chronic toxicity assays supports the conclusion that the toxicity of tropanyl dichlorobenzoate is mediated primarily by its effect on pharyngeal pumping.

The differential factor between the IC₅₀ values for tropanyl dichlorobenzoate in the presence and absence of exogenous serotonin also implies that DCP-45228 (8) may have an IC₅₀ and therefore a chronic EC₅₀ approximately equal to 6 μM in the absence of added serotonin.

It is clear from these results that with regard to inhibition of nematode pharyngeal pumping, a number of tropanyl esters, with both minor and major variations or substitutions in the carboxylic acid moiety, have activity superior to ondansetron and comparable with, and in one case superior to, tropanyl dichlorobenzoate. It is apparent that a range of additional substitutions, both in the carboxylate and tropanyl moieties, have efficacy in inhibiting nematode pharyngeal pumping.

The activity of the phthalic acid derivative DCP-45238 (18) and also of the indole derivative DCP-45240 (20) shows that a range of other substituted cyclic rings are effective. Similarly, such substituted ring structures can be combined with any of the other basic side chains which, like tropane, have been shown to produce 5-HT₃ antagonists with mammalian efficacy. These combinations would include the side chains and rings present in other known 5-HT₃ receptor-antagonists including metoclopramide (21), BMY 25801 (22), dimethpramide (23), zacopride (24), renzapride (25), and dazopride (26), and pancopride (27), MDL 72422 (28), BRL 24682 (29), Y-25130 (30), ADR 851 (31), ADR 847 (32), LY 277359 (33), ICS 205,930 (34), MDL 73,147 (35), granisetron (36), BRL 46470 (37), DAU 6215 (38), BIMU 0001 (39), L683,877 (40), AS-5370 (41), ondansetron (42), GR68755 (43) and GR65630 (44) (King, 1994). Similarly, while the ester linkage is clearly compatible with high levels of potency, other linkages between the basic and aromatic groups, such as imino, epithio and epoxy linkages are also useful.

Discussion

The data presented herein, as well as the data provided in co-pending WO 01/61000, indicate that the stimulation or inhibition of nematode pharyngeal pumping by 5-HT₃ selective agents occurs across three chemical classes, namely simple substitutions of 5-hydroxytryptamine (2-methyl-5-hydroxytryptamine hydrochloride), an indolyl with a basic imidazole side chain (namely ondansetron) and a range of tropanyl esters of carboxylic acid-substituted rings. It is concluded that inhibition of pharyngeal pumping and therefore toxicity to helminths and arthropods (particularly arthropods that use a muscular pump for feeding such as aphids), is a general feature of any compound which specifically inhibits 5-HT₃ receptors. All such known compounds are therefore potential nematicides and insecticides. Relative potency and specificity towards the invertebrate specific receptor is related to, but not identical to, the potency and specificity for mammalian 5-HT₃ receptors. However, using the bead ingestion assay, it is a straightforward matter to screen through known mammalian 5-HT₃ antagonists and related compounds such as those listed in King (1994) and derivatives thereof for those with suitable potency and specificity.

It is also of note that the mammalian toxicity of many 5-HT₃ antagonists is well-characterised and that a number are relatively well-tolerated (e.g. granisetron and ondansetron) and are registered for human therapeutic use (i.e. ondansetron). It is therefore feasible, by judicious choice of compounds, to achieve the selective toxicity which would be required for animal and human anthelmintics. It is believed that this is because the serotonergic signalling in the mammalian gut is involved in the emetic response rather than being critical to the normal healthy functioning of the gut as it is in nematodes and some other invertebrates.

All publications discussed above are incorporated herein in their entirety.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

Avery, L., and Horvitz, H. R. (1990). Effects of starvation and neuroactive drugs on feeding in Caenorhabditis elegans. J. Exp. Zool., 253, 263-70.
Brenner, S. (1974). The genetics of Caenorhabditis elegans. Genetics, 77, 71-94.
Brownlee, D. J. A. et al. (1997). Actions of the anthelmintic ivermectin on the pharngeal muscle of the parasitic nematode, Ascans suum. Parasitol., 115, 553-61.
Bunnin, B. A. (1998). “The Combinatorial Index”, Academic Press, San Diego.
Campbell, J. L. et al. (1978). Genetic recombination and complementation between bacteriophage T7 and cloned fragments of T7 DNA. Proc. Natl. Acad. Sci. USA, 75, 2276-80.
Davies, P. A. et al. (1999). The 5-HT_{3B} subunit is a major determinant of serotonin receptor function. Nature, 397, 359-63.
Evans, K and Haydock, P. (1999). Control of plant parasitic nematodes. Pesticide Outlook, 10, 107-11.
King, F. D. (1994). “Structure activity relationships of 5-HT₃ receptor antagonists, in 5-hydroxytryptamine-3 receptor antagonists”. Ed. F. D. King, B. J. Jones and G. J. Sanger pp. 1-43. CRC Press, Boca Raton, Fla.
March, J. (1985). “Advanced Organic Chemistry”, John Wiley, NY, 3^{rd} edition.
Maricq, A. V. et al. (1991). Primary structure and functional expression of the 5-HT₃ receptor. A serotinin-gated ion channel. Science, 254, 432-37.
Miyake, A. et al. (1995). Molecular cloning of human 5-hydroxytryptamine3 receptor: heterogeneity in distribution and function among species. Mol. Pharmacol., 48, 407-16.
Needleman, S. B. and Wunsch, C. D. (1970). A general method applicable to the search for similarities in the amino acid sequence of two proteins. J. Mol. Biol., 48, 443-53.

1-48. (canceled)

49. A method for controlling a pest selected from helminths and arthropods, said method comprising exposing said pest to an effective amount of a compound comprising one of the following formulae: 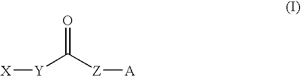
in which,
X is selected from substituted and unsubstituted cyclic rings,
Y is absent or otherwise selected from substituted of unsubstituted alkyl, substituted or unsubstituted alkyloxy, optionally interrupted by one or more heteroatoms,
Z is selected from substituted or unsubstituted alkyl, O, N, NH, S and SH, and
A is selected from nitrogen-containing substituents; 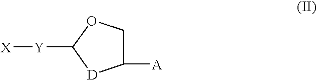
in which,
X, Y and A are as defined above, and
D is selected from C, CH, CH₂, O and N; and 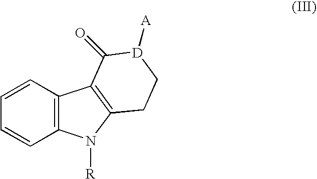
in which,
A and O are as defined above,
R is H or alkyl;
with the proviso that said compound is not ondansetron or tropanyl dichlorobenzoate.

50. The method of claim 49, wherein X of formula (I) or (II) is a mono- or bi-cyclic ring.

51. The method of claim 49, wherein X of formula (I) or (II) comprises at least one substituted or unsubstituted aromatic and/or heterocyclic rings which may be fused or non-fused.

52. The method of claim 49, wherein X of formula (I) or (II) is selected from mono-, di- and tri-substituted phenyl.

53. The method of claim 49, wherein Y is absent and X is bonded directly to the carbon of the C═O group.

54. The method of claim 49, wherein Y is a substituted or unsubstituted lower alkyl.

55. The method of claim 49, wherein Y is a substituted or unsubstituted lower alkyloxy.

56. The method of claim 49, wherein Y is a heteroatom selected from the group consisting of: O, N, NH, Sand SH.

57. The method of claim 49, wherein Z of formula (I), Z is O or NH.

58. The method of claim 49, wherein Z of formula (I) is a substituted or unsubstituted lower alkyl.

59. The method of claim 49, wherein A comprises nitrogen-containing substituents with a basic characteristic.

60. The method of claim 49, wherein A comprises an alkylamine.

61. The method of claim 49, where A of formula (III) is a heterocyclic or heterocyclicalkyl.

62. The method of claim 49, wherein O of formula (II) is CH or N.

63. The method of claim 49, wherein R of formula (III) is lower alkyl.

64. The method of claim 49, wherein the compound comprises the following formulae:

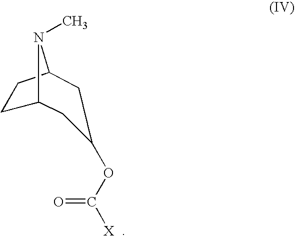

65. The method of claim 64, wherein X of formula (IV) is selected from substituted and unsubstituted phenyl, phenoxyalkyl, phenyl alkyl, cubanyl carboxylate, cycloalkyl, cycloalkyl carboxylate, benzylcarboxylate, pyridine carboxylate, indolyl.

66. The method of claim 64, wherein X of formula (IV) is selected from substituted and unsubstituted phenyl, benzylcarboxylate, and indolyl.

67. The method of claim 64, wherein the compound is selected from the group consisting of 3-chloro-benzoic acid tropan-3-yl ester, 3,4-dichloro-benzoic acid tropan-3-yl, 2-fluoro-benzoic acid tropan-3-yl ester, phthalic acid methyl ester tropan-3-yl ester, and 1H-indole-3carboxylic acid tropan-3-yl.

68. A composition for controlling a pest selected from helminths and arthropods, said composition comprising a compound according to claim 49 in combination with a pharmaceutically/veterinary/agriculturally acceptable carrier and/or excipient.

69. A compound of the formulae: 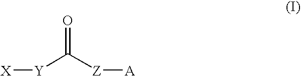
in which,
X is selected from substituted and unsubstituted cyclic rings,
Y is absent or selected from lower alkyl, lower alkyloxy, O, N, NH, S and SH, Z is O, and
A is tropanyl,
with the proviso that compound is not tropanyl dichlorobenzoate.

70. The compound of claim 69, wherein Y is absent.

71. The compound of claim 69, wherein the compound comprises the following formulae:

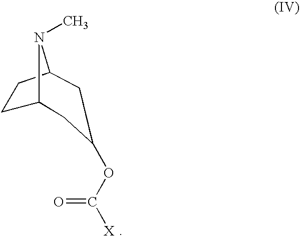

72. The compound of claim 71, wherein X of formula (IV) is selected from substituted and unsubstituted phenyl, phenoxyalkyl, phenyl alkyl, cubanyl carboxylate, cycloalkyl, cycloalkyl carboxylate, benzylcarboxylate, pyridine carboxylate, indolyl.

73. The compound of claim 71, wherein X of formula (IV) is selected from substituted and unsubstituted phenyl, benzylcarboxylate, and indolyl.

74. The compound of claim 71, selected from the group consisting of 3chloro-benzoic acid tropan-3-yl ester, 3,4-dichloro-benzoic acid tropan-3-yl ester, 2-fluoro-benzoic acid tropan-3-yl ester, phthalic acid methyl ester tropan-3-yl ester, and 1H-indole-3-carboxylic acid tropan-3-yl.

75. A composition for controlling a pest selected from helminths and arthropods, said composition comprising a compound according to claim 69 in combination with a pharmaceutically/veterinary/agriculturally-acceptable carrier and/or excipient.

76. An assay for identifying and/or assessing an helminth and/or arthropod control compound, the method comprising determining the ability of a candidate compound to modulate the activity of a 5-HT₃ receptor of the helminth or arthropod, wherein the candidate compound is a compound as defined in claim 49 or claim 69.

77. The assay of claim 76, wherein the modulation of 5-HT₃ activity is determined by measuring changes in cell membrane potential or Ca2+ levels.

78. The assay of claim 76, wherein the 5-HT₃ receptor(s) is contacted simultaneously with a serotonergic ligand and the candidate compound, and the modulation of 5-HT₃ activity is determined by measuring the amount of bound and/or unbound labelled serotonergic ligand.

79. An helminth and/or arthropod control compound identified by an assay according to claim 76.


SEQUENCE LISTING (3 sequences)

SEQ ID NO: 1 - protein, 635 aa, Caenorhabditis elegans
MIICYSCLTVSILLTIKFVPCRFAGIEHQNTKSRVHFSLLDSRQENDTNHFEIAEAKFQKPHNEENTIGTITKFAPSVQEQHSSAVIPMPHFDQNRLEQALRIKGSIDGTEEALYRSLLDHTVYEKDVRPCIHHSQPTNVTFGFLLNQIVEMDERNQALTTRSWLNINWMDPRLSWNESLWSEIKAIYIPHARIWKPDIILVNNAIREYYASLVSTDVMVTSDGNVTWLFSALFRSSCPIRVRYYPFDDQQCDLKFASWSHDITEINLGLNTDKGDLSSYMNNSEFDLVDMTAVREVVTFPSDTNSDWPIIVIRIHMHRRPLFYVFNHIVPCVLISSMAVLGFLMPPETGEKINMIITTLLSMGVYLQSITESIPPTSEGVPLIGMYYVSSLLMVCLATCVNVITLNMHRNGAANQGRHVPAWMQKWILGYLATFMRMSIREPDSIALLKASQSKKSTIRRSSILRDLKRVKNMSNVRAKSKEQNANRECECMDPLVHIYAESIMSCLAADTKPMNGSTIREDFASESTFLGRVVSDGIMPRISASSNSVLTEFETRFRRILKRVYRSLQQHEIREEILDERSRIQWQWQQLASVVDRLLLCLFCTATLFTIICLLIVPVAYRDNDSMLSFLNFF

SEQ ID NO: 2 - protein, 479 aa, Caenorhabditis elegans
MLLPILLHFLLLITQLNGSPAEVRLINDLMSGYVREERPTLDSSKPVVVSLGVFLQQIINLSEKEEQLEVNAWLKFQWRDENLRWEPTAYENVTDLRHPPDALWTPDILLYNSVDSEFDSSYKVNLVNYHTGNINWMPPGIFKVSCKLDIYWFPFDEQVCYFKFGSWTYTRDKIQLEKGDFDFSEFIPNGEWIIIDYRTNITVKQYECCPEQYEDITFTLHLRRRTLYYSFNLIAPVLLTMILVILGFTVSPETCEKVGLQISVSLAICIFLTIMSELTPQTSEAVPLLGVFFHTCNFISVLATSFTVYVQSFHFRNQHVHERMDFWMRFILLEWSPWLLRMKMPDRENNFQTLTESWKGRNRRESMARTAFEYADGPVTQIHSMGIMLKDNFEELIYQVKQEKIADEKGIERLRVLQKIYDHVKMIREHDDDNDEDSRVALEWRFAAIVVDRLCLLAFSLLIVVVSIIIALRAPYLFA

SEQ ID NO: 3 - protein, 554 aa, Caenorhabditis elegans
MRRRFEIGIAFFFALFRVIWTGDHERRLYAKLAENYNKLARPVRNESEAVVVLLGMDYQQILDIDEKHQIMNSSVWLRMSWTDHYLTWDPSEFGNIKEVRLPINNIWKPDVLLYNSVDQQFDSTWPVNAVVLYTGNVTWIPPAIIRSSCAIDIAYFPFDTQHCTMKFGSWTYSGFFTDLINTTISPATYKPNGEWELLGLTSQRSIFFYECCPEPYYDVTFTVSIRRRTLYYGFNLLLPCMLISSLALLSFTLPADCGEKLNLGVTIFMSLCVFMIMVAEAMPQTSDALPLIQIYFSCIMFQVGASVVATVIALNFHHRSPEQYKPMNKFLKTLLLGWLPTLLGMERPDVLELSVHGAHYASDNKKKQRQYLIEVERHILTRPNGNGHSAVDKAVHLDLSTGNPHSDAKKSSPSPKRTSASIMGMTGLPTTQMNGALDSSINKYTCTKVTRPLENGSATINHKSSPQINPINNNNIYKCANNQKTQFEDRHFHHILNELRVISARVRKEEAMHALQADWMFASRVVDRVCFLAFSAFLFMCTAIISYNAPHLFV